(19) United States
(12) Patent Application Publication
(10) Pub. No.: US 2012/0128834 A1
(43) Pub. Date: May 24, 2012

(54) Product And Apparatus For The Preparation Of A Milkshake

(75) Inventors: Michael Jurjen Westdijk, Enschede (NL); Jan Gerhard Land, Enschede (NL)

(73) Assignee: Dairy Innovations B.V., Arnhem (NL)

(21) Appl. No.: 13/319,442

(22) PCT Filed: May 7, 2010
(86) PCT No.: PCT/IB2010/052033

§ 371 Date: Jan. 31, 2012

(30) Foreign Application Priority Data
May 8, 2009 (NL) 2002858

(51) Int. Cl. A47J 43/27; B65D 69/00; B65D 85/78; A23G 3/02

(52) U.S. Cl. 426/112; 99/452; 206/223

(57) ABSTRACT

Product for the preparation of a milkshake, covering a substantially liquid tight closable container for the containment of a to be prepared milkshake, a multiplicity of units of ice put into the tool, and in the container present fractionating mean for the division of units of ice into small parts, whereby the fractionating means are arranged in the container in such a way that the units of ice can be divided into small parts by shaking the container with the present units of ice and a by the consumer added liquid.

The invention relates to a packed half product for the preparation of a milkshake.

De term milkshake has to be explained as a cold, airy, thick-liquid drink, acquired by the mixing of ice and milk, fruit, fruit pulp, fruit drinks, jams, fruit syrup, chocolate milk and the like. Of importance in this case is that the ingredients are being mixed well, that the mixture has a temperature which is preferably lower than 0° C., more specific between −2° C. and −1.5° C., and that the viscosity is preferably that kind of that it can be drunk/eaten through a straw. The last can among other things be achieved by the enclosing of a gas, like air, in the mixture.

The whipping and enclosing of a gas in the mixture can be achieved in different ways, like the use of mechanical or hand operated mixers or rods. It is also possible that a gas or gas holding element can be added to the mixture.

An objection of existing ways of operating is that for preparation of a good milkshake special equipment is needed and/or ingredients have to be measured well. The invention aims to overcome these objections in an efficient, effective and/or simple way.

Therefore, according to the invention, the half product contains a multiplicity of units of ice, and tools to divide the units of ice in small parts of ice, whereby the fractionating means and the number of units of ice are packed together in a consumer packaging, and whereby the fractionating means are arranged in such a way that the units of ice can be divided in small parts by taken the fractionating mean with the enclosed units of ice out of the packaging and putting them in a, in particular fluid tight, container and shaking this container together with a liquid which has been added by the user.

In this context the word ice among others refers to: ice cream, water ice, frozen curd, yoghurt, and etcetera.

The fractionating means and the units of ice are preferably designed in such a way that a good heat transfer between liquid and ice can occur, which makes it possible that the milkshake preferably can be produced within 30 seconds.

The units of ice are preferably spherical shaped, whereby the liquid can spread between the units of ice easily, when these are situated against each other.

The fractionating means cover preferably a perimeter wall in or on which the units of ice are placed, whereby these simultaneously function as container for the ice. The fractionating means are preferably produced of a plastic or plasticized carton board.

The perimeter wall can be rolled, bended or folded in a preferred version. This for example makes it easier for the consumer to put the half product after purchase in a design that is fitting with the container. The perimeter wall in another preferred version is substantially reel shaped, more over preferably substantially cylindrical shaped, for example if the half product already has been place in a container for sale to a consumer.

The fractionating means are preferably accommodated with a multiplicity of knives for the cutting of the units of ice, in such a way that the units of ice are being moved against the edges of the knives by shaking. From this viewpoint the knives preferably point in the axial direction, and the knives have preferably edges that point in both axial directions. The perimeter wall is preferably provided with holes; wherefore during shaking air is brought into the mixture. The knives and the holes are being shaped preferably by inward bended parts of the perimeter wall, and the knives are preferably triangular shaped. Further, the knives are preferably regular spread among the surface of the perimeter wall. During shaking the knives that stick out occur turbulence in the already cut mixture, whereby the air injection is advanced.

As well the invention covers a product for the preparation of a milkshake, containing an in particular liquid tight container for containing the milkshake to be prepared, a multiplicity of units of ice that are being placed in the container and fractionating means that are being placed in the container for the partitioning of the units of ice into small parts, whereby the fractionating means are placed in the container in such a way that the units of ice can be divided into small parts by shaking the container with inside the container the present units of ice and a liquid that has been added by the user.

As well the invention covers an apparatus for the preparation of a milkshake, containing fractionating means for the division into small parts of units of ice, whereby the fractionating means are designed in such a way that the units of ice can be divided in small parts by the fractionating means with the enclosed units of ice, by placing them in a substantially liquid tight container and shaking this container together with a liquid which has been added by the user.

The invention will be explained on the basis of example presentations shown in figures, in which:

FIGS. 1, 2 and 3 show a product in perspective according to the invention in several stages of the preparation of a milkshake;

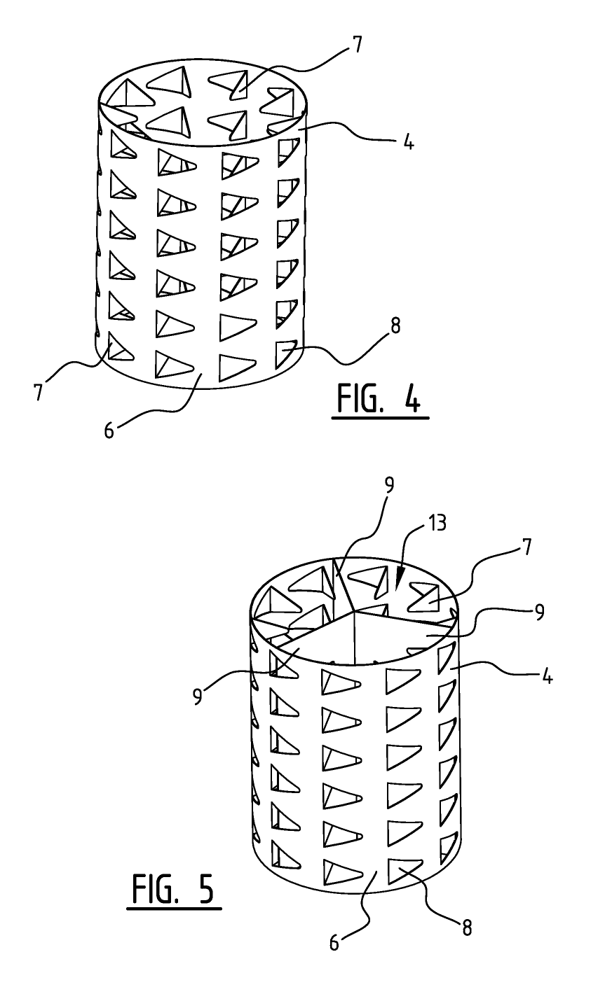

FIG. 4 in perspective shows the partitioning element from FIGS. 1, 2 and 3;

FIGS. 5, 6, 7, 10 and 11 show in perspective several alternative embodiments of the partitioning element, and

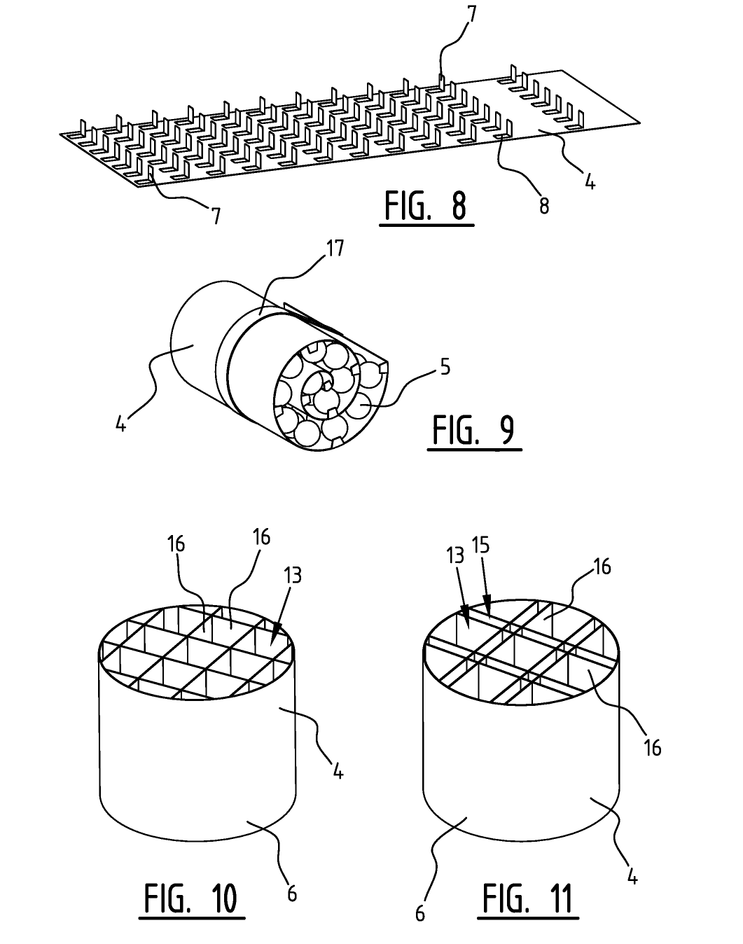

FIGS. 8 and 9 in perspective show an embodiment from a rolled partitioning element, whereby in FIG. 9 the partitioning element has been rolled filled with balls of ice.

According FIGS. 1, 2 and 3 a product for the preparation of a milkshake contains a container 1, containing a substantially cylindrical cup 2 of circa 600 ml with a connectable lid 3, and a substantially cylindrical partitioning element 4, in which bolls of ice cream 5 are put. The through cut of partitioning element 4 is circa 10-20% smaller than the through cut of container 1, and the length of the partitioning element is circa 30% to 70% smaller than the height of the container 1.

The enclosed container 1, and the partitioning element 4 filled with the bolls of ice cream can be sold as product to the consumer. As alternative it is possible to sell partitioning element 4 filled with bolls of ice 5 in a disposable packaging to the consumer, whereby the consumer is given the opportunity to buy container 1 separately, whether filled with liquid or not. Depending on the kind of ice the product can be sold in melted condition and can be frozen by the consumer self at home in a freezer.

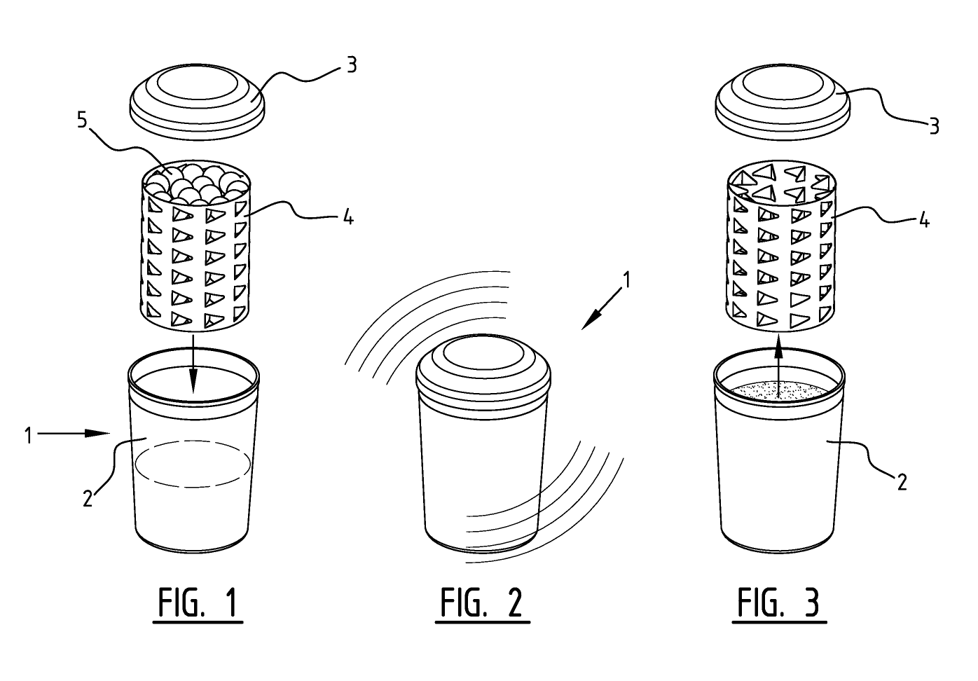

In both cases the consumer fills container 1, with the partitioning element 4 with the frozen ice bolls 5, for example with cooled milk (FIG. 1). Following the consumer closes the container 2 with lid 3 and shakes it during circa 30 seconds up and down (FIG. 2). Following the container 1 can be opened and the partitioning element 4 can eventually be removed (it is possible to leave the partitioning element 4 in the container, and drink the milkshake with a straw).

In an alternative embodiment partitioning element 4 filled with the frozen ice bolls is packed in a first share part, and for example the cooled milk is packed in a second share part. After the lids of both share parts are being taken off, the two share parts can be connected to each other with the open sides, for example by screwing, to form one container 4 and the combination can be shaken. One of the bottoms of the share parts is in this case supplied with a sealed opening to put in a straw.

The partitioning element 4 according FIG. 4 contains a cylindrical wall of thin plate material, in which V-shaped cutters shaped triangular knives 7 that are bended inwards because of which holes 8 are being shaped. The knives 7 thereby point in axial direction. The partitioning element according FIG. 5 contains furthermore three walls 9 that stretch radial outwards from the axes of the wall to wall 6, by which three compartments 13 in the partitioning element 4 are being shaped. These walls 9 also serve as knives to divide the ice. In a version of the embodiment of FIG. 4 walls 9 point about the direction of the central axes from the cylindrical perimeter wall, but are over there not connected to each other, and reach furthermore just a part of the length of the cylindrical perimeter wall 6, for example in the middle of it.

In this way the wall parts form flexible knives that create turbulence and prevent the forming of a big lump of ice.

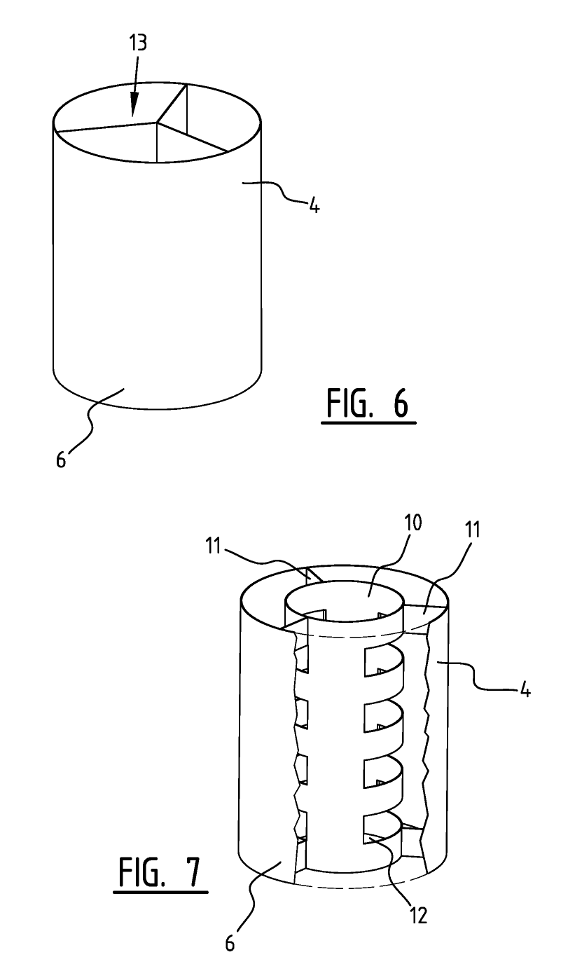

FIG. 6 shows an embodiment of a partitioning element 4 in which the knives 7 and the holes 8 in the perimeter wall 6 of FIG. 5 are taken out.

FIG. 6 shows an embodiment whereby within the perimeter wall 6 a cylindrical inner wall 10 has been applied, between which radial connecting elements 11 expend. In the inner wall 9 holes 12 are applied. The rims of the holes 12, the connecting elements 11 and the walls 6, function all as knives during the shaking.

FIG. 10 shows an embodiment whereby in the cylindrical perimeter wall 6 by flat walls 16 in a diamond pattern axial expending compartments 13 are applied, which are being filled with ice bolls 5. Also here the rims of the walls 6, 16 function as knives. FIG. 11 shows a version whereby the compartments have different sizes, whereby only the big compartments are filled with bolls of ice 5. This causes that the liquid can freely flow through the in between laying compartments 15, whereby the heat transfer is improved.

FIGS. 8 and 9 show an embodiment whereby the bolls of ice 5 are applied on a flat wall 6 made of plastic, which has been applied with die-cut and bended rectangular knives 7 on which the bolls of ice 5 are being pressed and connected. This way the half product is packed in a disposable packaging. The consumer can after sales roll the partitioning element 4 with the bolls of ice 5 to a cylindrical element and secure it with for example a rubber band 17, in such a way that the knives 7 expend in axial direction.

1. Packed half product for the preparation of a milkshake, containing a multiplicity of units of ice, and fractionating means for the division into small parts of the units of ice, whereby the fractionating means and the multiplicity of units of ice are packed together in a consumer packaging, and whereby the fractionating means are arranged in such a way that the units of ice can be divided into small parts by taking the fractionating means filled with the containing units of ice out of the packaging and placing them in a substantially liquid tight container and shaking this container together with a liquid that has been added by the consumer.

2. Packed half product according to claim 1, whereby the units of ice are boll shaped.

3. Packed half product according to claim 1, whereby the fractionating means contain a perimeter wall in or upon which the units of ice are put.

4. Packed half product according to claim 3, whereby the perimeter wall is rollable, bendable or foldable.

5. Packed half product according to claim 1, whereby the perimeter wall substantially is reel shaped, preferably substantially cylindrical shaped.

6. Packed half product according to claim 1, whereby the fractionating means are provided with a multiplicity of knives for the cutting of units of ice.

7. Packed half product according to claim 1, whereby the perimeter wall is provided with holes.

8. Packed half product according to claim 6, whereby the knives and the holes are configured by inwards bended parts of the perimeter wall.

9. Packed half product according to claim 6, whereby the knives substantially are triangular shaped.

10. Packed half product according to claim 6, whereby the knives substantially are spread regular across the surface of the perimeter wall.

11. Packed half product according to claim 6, whereby the knives expend in axial direction.

12. Packed half product according to claim 11, whereby the knives have cutting edges that are pointing at both axial sides.

13. Packed half product according to claim 1, whereby the fractionating means are produced from plastic or plasticized carton board.

14. Product for the preparation of a milkshake, covering a substantially liquid tight container to contain the to be prepared milkshake, a multiplicity of ice units applied in the container, and in the container present fractionating means for the partitioning of the ice units in small parts, whereby the fractionating means are applied in the container in such a way that the units of ice can be divided by the container by shaking with the present units of ice and by a by the consumer added liquid.

15. Apparatus for the preparation of a milkshake, covering fractionating means for the partitioning into small parts of the units of ice, whereby the fractionating means are arranged in such a way that the applied units of ice can be divided by the fractionating mean by placing the fractionating mean in a substantially liquid tight container and shaking the container together with a by the consumer added liquid.
